(19) United States
(12) Patent Application Publication
(10) Pub. No.: US 2005/0240474 A1
(43) Pub. Date: Oct. 27, 2005

(54) Pattern based promotion evaluation

(75) Inventor: Chang Li, Toronto (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, ARMONK, NY (US)

(21) Appl. No.: 11/109,395

(22) Filed: Apr. 19, 2005

(30) Foreign Application Priority Data
Apr. 21, 2004 (CA) 2,465,064

(51) Int. Cl. G06F 17/60

(52) U.S. Cl. 705/14

(57) ABSTRACT

In an embodiment of the present invention there is provided a computer implemented method to evaluate a purchase condition and to calculate the associated rewards. The embodiment performs a pattern based evaluation of promotion incentives in electronic commerce systems, wherein the patterns used are mainly derived from shopping activity and not the user. The computer implemented method of an embodiment of the present invention performs pattern based promotion evaluation based on a promotion definition for a plurality of items to be purchased for an electronic commerce application. The embodiment comprises defining a purchase pattern of items derived from a promotion definition and then determining the defined purchase pattern of items within the plurality of items being purchased. Next counting the number of occurrences of the defined purchase pattern found and selectively applying a filter derived from the promotion definition to an occurrence. Then determining promotion definition conditions having been met and determining one or more rewards from the promotion definition to complete the evaluation.

### FIELD OF THE INVENTION

This present invention relates generally to promotion incentives in electronic commerce systems and more specifically to pattern based evaluation of promotion incentives in electronic commerce systems.

### BACKGROUND OF THE INVENTION

In an electronic commerce system promotions may be used to entice customers to return to a site to generate more sales and related profit. The types of promotions offered may be quite simple such as a percentage discount or fixed amount off a purchase price, free shipping of an item or a free gift for shopping. Promotions when offered usually have certain conditions attached to the offer. For example a customer may need to make some minimum purchase amount before being offered the promotion as a means of qualifying for the promotion. In order to provide the promotion to purchasers who have met the required conditions the system first has to evaluate the conditions and terms of purchase and then make a determination. While the determination may be relatively easy it is the evaluation of the conditions and the shopping results in support of those conditions that may prove to be difficult in many cases. Such difficulty may cause systems available today to limit the number of promotion types that are available for use. If a variety of promotions are offered and supported by the electronic commerce systems support is then usually provided on a promotion type by type basis. Providing support in this manner may result in having little infrastructure in place to support future reuse. This approach also may increase the burden of code maintenance and reduce the system's ability to support multiple promotion types concurrently.

Previous systems have been implemented to track and report on customer loyalty. Tracking customer loyalty or other forms of history data has provided one form of information on which to base rewards. The loyalty levels allow customers to redeem certain benefits in the form of awards. Still other systems have implemented a categorized approach to purchases allocating codes to categories and updating advertisers by category, again as examples of maintaining and analysing customer history data. Rewards may vary to include coupons which are also dependent upon previous shopping behaviour of a specific customer. Other systems have implemented means for providing a promotional item based on a customer response such as that during the viewing of an advertisement. This type of promotion tends to be “instant” in that a promotion is selected or made available right after completion of the event. In general many systems have been developed to monitor and track customer purchasing behaviour as a means of establishing rewards.

Other systems have used “smart cards” to keep track of customer purchase activity in addition to other customer data to develop personalized or promotional greetings and services.

It would therefore be highly desirable to be able to perform promotion evaluation mainly based on current shopping activity in an efficient manner.

### SUMMARY OF THE INVENTION

Conveniently, software in an embodiment of the present invention provides a method, system and article that may be used to describe a purchase condition in a promotion and the associated rewards, in order to evaluate a purchase condition and to calculate the associated rewards. Specifically the present invention focuses on pattern based evaluation of promotion incentives in electronic commerce systems, wherein the patterns used are mainly derived from shopping activity and not the user.

In an embodiment of the present invention there is provided a computer implemented method for pattern based promotion evaluation based on a promotion definition for a plurality of items to be purchased for an electronic commerce application, comprising: defining a purchase pattern of items derived from the promotion definition; determining the defined purchase pattern of items within the plurality of items; counting the number of occurrences of the defined purchase pattern found; selectively applying a filter derived from the promotion definition to an occurrence; determining promotion definition conditions having been met; and determining one or more rewards from the promotion definition to complete the evaluation.

In another embodiment of the present invention there is provided a computer system for pattern based promotion evaluation based on a promotion definition for a plurality of items to be purchased for an electronic commerce application, comprising: a means for defining a purchase pattern of items derived from the promotion definition; a means for determining the defined purchase pattern of items within the plurality of items; a means for counting the number of occurrences of the defined purchase pattern found; a selector for selectively applying a filter derived from the promotion definition to an occurrence; a means for determining promotion definition conditions having been met; and a means for determining one or more rewards from the promotion definition to complete the evaluation.

In yet another embodiment of the present invention there is provided an article of manufacture for directing a data processing system for pattern based promotion evaluation based on a promotion definition for a plurality of items to be purchased for an electronic commerce application, the article of manufacture comprising: a computer usable medium embodying one or more instructions executable by the data processing system, the one or more instructions comprising: data processing executable instructions for defining a purchase pattern of items derived from the promotion definition; data processing executable instructions for determining the defined purchase pattern of items within the plurality of items; data processing executable instructions for counting the number of occurrences of the defined purchase pattern found; data processing executable instructions for selectively applying a filter derived from the promotion definition to an occurrence; data processing executable instructions for determining promotion definition conditions having been met; and data processing executable instructions for determining one or more rewards from the promotion definition to complete the evaluation.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate embodiments of the present invention by example only,

FIG. 1 is a block diagram showing the components of a system in which an embodiment of the present invention may be implemented;

FIG. 2 is a flowchart of operations in evaluating a promotion using an embodiment of the present invention;

FIG. 3a is a flowchart of the reward calculation as in the embodiment of FIG. 2; and

FIG. 3b is a block diagram of the reward expression of the embodiment of FIG. 3a.

Like reference numerals refer to corresponding components and steps throughout the drawings.

### DETAILED DESCRIPTION

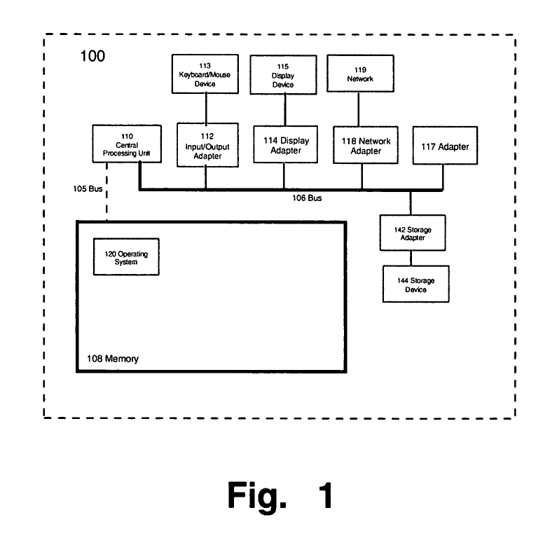

FIG. 1 depicts, in a simplified block diagram, a computer system 100 suitable for implementing embodiments of the present invention. Computer system 100 has a central processing unit (CPU) 110, which is a programmable processor for executing programmed instructions, such as instructions contained in memory 108. Memory 108 can also include hard disk, tape or other storage media. While a single CPU is depicted in FIG. 1, it is understood that other forms of computer systems can be used to implement the invention, including multiple CPUs. It is also appreciated that the present invention can be implemented in a distributed computing environment having a plurality of computers communicating via a suitable network 119, such as the Internet.

CPU 110 is connected to memory 108 either through a dedicated system bus 105 and/or a general system bus 106. Memory 108 can be a random access semiconductor. Memory 108 is depicted conceptually as a single monolithic entity but it is well known that memory 108 can be arranged in a hierarchy of caches and other memory devices. FIG. 1 illustrates that operating system 120, may reside in memory 108.

Operating system 120 provides functions such as device interfaces, memory management, multiple task management, and the like as known in the art. CPU 110 can be suitably programmed to read, load, and execute instructions of operating system 120. Computer system 100 has the necessary subsystems and functional components to implement testing of files as will be discussed later. Other programs (not shown) include server software applications in which network adapter 118 interacts with the server software application to enable computer system 100 to function as a network server via network 119.

General system bus 106 supports transfer of data, commands, and other information between various subsystems of computer system 100. While shown in simplified form as a single bus, bus 106 can be structured as multiple buses arranged in hierarchical form. Display adapter 114 supports video display device 115, which is a cathode-ray tube display or a display based upon other suitable display technology that may be used to depict data. The Input/output adapter 112 supports devices suited for input and output, such as keyboard or mouse device 113, and a disk drive unit (not shown). Storage adapter 142 supports one or more data storage devices 144, which could include a magnetic hard disk drive or CD-ROM drive although other types of data storage devices can be used, including removable media for storing promotion and reward data.

Adapter 117 is used for operationally connecting many types of peripheral computing devices to computer system 100 via bus 106, such as printers, bus adapters, and other computers using one or more protocols including Token Ring, LAN connections, as known in the art. Network adapter 118 provides a physical interface to a suitable network 119, such as the Internet. Network adapter 118 includes a modem that can be connected to a telephone line for accessing network 119. Computer system 100 can be connected to another network server via a local area network using an appropriate network protocol and the network server can in turn be connected to the Internet. FIG. 1 is intended as an exemplary representation of computer system 100 by which embodiments of the present invention can be implemented. It is understood that in other computer systems, many variations in system configuration are possible in addition to those mentioned here.

It is assumed that a relationship between promotions, for example how promotions are organized and how to detect and resolve a conflict situation between promotions is known and has been resolved. The focus is now on how to define and evaluate one single promotion.

Conceptually, a promotion has conditions and rewards. When conditions of the promotion are satisfied, the rewards will be calculated and applied to a purchase order. A promotion may have many types of conditions associated with it. Primarily for the purposes of the disclosure, there are five different types of conditions:
Schedule conditions that limit the promotion to be applicable only within a certain period of time;
Targeting conditions that restrict the application of a promotion to only a sub set of shoppers;
Promotion code condition requires a correct code to be entered before the promotion can be applied;
Application limit constraints limits the number of times a promotion can be applied either to an order, to a shopper, or overall;
Purchase condition requires the shopper to have purchased a certain combination of products or spend a certain amount on certain combination of products.

When all conditions associated with a promotion are satisfied the respective rewards are then calculated and applied. The first four types are often referred to as pre-conditions. These conditions are the constraints a shopper has to satisfy before the purchase condition is even evaluated. These conditions generally have a simple model and are easy to implement.

The following is a listing of typical promotions that will be used to provide meaningful insight into the understanding of various aspects of promotions and rewards.
1. Buy 1 to 3 bottles of water get 10% off, 4 to 6 bottles get 20% off, 7 or more get 30%;
2. Buy the first 3 bottles of water get 10% off, next 3 at 20%, 30% of any additional purchases;
3. Buy 3 bottles of water for $20;
4. Buy a water cooler and one bottle of water for $129;
5. Buy a water cooler, take up to 4 bottles of water at 50%;
6. Buy 3 3-gallon or 5-gallon water bottles get 10% off;
7. Buy 3 water bottles of the same size either 3-gallon or 5-gallon, get 10% off;
8. Buy a water cooler and a 5 gallon water bottle get 10% off the water cooler and get the water bottle for $1;
9. Buy a water cooler and a water bottle for $129 or free shipping;
10. Buy a water cooler and a water bottle for $129 and free shipping;
11. Buy a water cooler and a water bottle valued at $150 dollar or more get free shipping;
12. Spend between $100-$200 on water bottles get 10% off; $200 to $300 get 20%; spend $300 get 30% off;

The first action is to understand what may be done to determine if a promotion is applicable. The following two examples of promotions one and two will be used:
Buy 1 to 3 bottles of water get 10% off, 4 to 6 bottles get 20% off, 7 or more get 30%;
Buy the first 3 bottles of water get 10% off, next 3 at 20%, 30% of any additional purchases;

Usually a cashier at the check-out counter would first find all of the water bottles in an order, and then based on the quantity determine which range the quantity falls in and then apply any adjustments associated with that range to the water bottles. A more abstract description of this process may be given as follows: 1) identify the purchase patterns targeted by the promotion (one single water bottle is a purchase pattern targeted by the promotion, and this pattern may occur multiple times in an order); 2) based on the number of times a pattern occurs, determine the distribution (1-3, 4-6, 7 or more?); 3) then based on the distribution calculate the rewards, in this case discount, associated with that range (10%, 20%, or 30%). This activity leads to a first and second observation of:
Observation 1: the evaluation of promotion may be done through a three-step process of pattern recognition, quantity distribution and reward calculation and Observation 2: purchase pattern usually is defined by specifying some selection criteria (any water bottle of the items).

This three-step process will be used throughout the disclosure in determining if a promotion is applicable. Also there is a difference between the two promotions in the way the quantity distribution was handled. When purchasing X number of water bottles, based on where X falls, in promotion 1, all of the water bottles will be discounted the same way, while in promotion 2, the purchased water bottles will be divided into tiers and discounted differently. The first type of distribution is known as a volume based distribution while the second type of distribution is known as tiered, which leads to a third observation:
Observation 3: The quantity distribution could be a volume based or tiered.

In the previous samples, the purchase pattern was comprised of one single item: a bottle of water. This may not always be the case. For example, in promotion number 3: Buy three bottles of water for $20, every three bottles of water are the targeted purchase pattern, leading to fourth observation:
Observation 4: Besides selection criteria, there may be a quantity requirement associated with the selection criteria. If a match of a purchase pattern is to be present in an order, both the selection criteria and the quantity requirement need to be satisfied as constraints.

In the first three promotions there was always a target pattern of a single type of item, that being a water bottle. In promotion number 4: Buy a water cooler and one bottle of water for $129, the targeted pattern is now a combination of a water cooler and a water bottle. This leads to our next observation:
Observation 5: If each selection criteria and quantity requirement combination could be called one constraint of a purchase pattern, a purchase pattern may be defined through multiple of these constraints.

For example using promotion number 5: Buy a water cooler, and take up to 4 bottles of water at 50%. In this case, if a customer has purchased 1 water cooler and 1 bottle of water, the purchase pattern is a match, and for 1 water cooler and 2 bottles of water, the purchase pattern is also a match; in fact if a customer buys 1 water cooler and between 1 and 4 bottles of water, the pattern is always a match with the promotion, leading to another observation:
Observation 6: The quantity requirement that is part of the definition of a purchase pattern can be either a single value or a range;

Promotion numbers 6 and 7 have been defined as: Buy 3 3-gallon or 5-gallon water bottles get 10% off; and Buy 3 water bottles of the same size either 3-gallon or 5-gallon, get 10% off, respectively. These two promotions are interesting because even though both target 3 and 5-gallon water bottles and the quantity requirement of three is the same. One requires all water bottles must be of the same size (homogeneous), the other doesn't (heterogeneous). The first promotion would have been satisfied by 2 bottles of 3-gallon water bottles and 1 5-gallon water bottle, but not the second. The difference in promotions may be seen by the level at which the selection criteria are joined by an “or” function. In promotion number 6, the “or” occurs at a low level, being 3 of any combination of 3 and 5 gallon water bottles, while in promotion number 7, the “or” is set at a higher level of 3 of either 3 gallon or 5 gallon water bottles, which leads to a seventh observation:
Observation 7: To sum it up, when the selection criteria convey an “or” semantic and the quantity requirement indicates a list is expected, in some cases the list is a homogeneous list, in other cases the list is a heterogeneous list.

With regard to promotion number 8: Buy a water cooler and a 5 gallon water bottle and get 10% off the water cooler and get the water bottle for $1; reveals that even when the targeted purchase pattern is a water cooler and a water bottle, the rewards may be different for the water cooler and the water bottle, leading to an eighth observation:
Observation 8: Rewards to different items in a target purchase pattern can be different;

Promotion number 9 is then defined as: Buy a water cooler and a water bottle for $129 or free shipping, providing a customer the choice of free shipping or a fixed price for the water cooler, which then provides a ninth observation:
Observation 9: Rewards for a purchase pattern can be presented as a choice of multiple options;

Promotion number 10 may appear at a glance to be the same as promotion nine, but it is defined as: Buy a water cooler and a water bottle for $129 and get free shipping. In this case, if one has purchased a water cooler and a bottle of water, he/she will get the package for $129 AND the free shipping, leading to observation ten:
Observation 10: Multiple rewards can be applied to items in a purchase pattern;

It may now be assumed that a customer has purchased two water coolers and two water bottles, one being an entry version of a water cooler priced at $69 with a water bottle priced at $10, and the other being a deluxe version of a water cooler priced at $169 with a water bottle priced at $20. If promotion number 11 was now applied: Buy a water cooler and a water bottle valued at $150 dollar or more and get free shipping, to this order, it may be observed that two patterns of “1 cooler and 1 bottle” are evident, however only the deluxe cooler and water bottle is eligible for the promotion in this case, leading to observation 11:
Observation 11: A filter on matched purchase patterns is needed in some cases to narrow the matched purchase patterns to the ones targeted by a promotion;

By comparing promotion number 1: Buy 1 to 3 bottles of water get 10% off, 4 to 6 bottles get 20% off, 7 or more get 30%, with promotion number 12: Spend between $100-$200 on water bottles get 10% off; $200 to $300 get 20%; spend $300 get 30% off, it would appear that both promotions target the same pattern: a water bottle and have the same three ranges and the same rewards associated with each range. However there is as difference in that the first promotion there is a range defined based on the number of water bottles purchased, while in the twelfth promotion the range is defined based on spending thresholds, which leads to a final observation:
Observation 12: The quantity distribution as mentioned in the 3-step promotion evaluation process could be more than the distribution of quantity, it can base on either quantity (or to be more precise, the number of matches for a purchase pattern in the order) or spending, similarly a spending threshold distribution can be volume based or tiered;

From now on, the generic term distribution will be used to refer to both quantity distribution and spending distribution. To summarize there are twelve observations made in the previous segments:
1. The evaluation of promotion may be done through a three-step process of pattern recognition, quantity distribution and reward calculation.
2. Purchase pattern usually is defined by specifying some selection criteria (any water bottle).
3. The quantity distribution could be a volume based or tiered.
4. Besides selection criteria, there usually is a quantity requirement associated with the selection criteria. If a match of a purchase pattern is to be present in an order, both the selection criteria and the quantity requirement need to be satisfied.
5. If each selection criteria and quantity requirement combination could be called one constraint of a purchase pattern, a purchase pattern may be defined through multiple of these constraints.
6. The quantity requirement that is part of the definition of a purchase pattern can be either a single value or a range;
7. To sum it up, when the selection criteria convey an “or” semantic and the quantity requirement indicates a list is expected, in some cases the list is a homogeneous list, in other cases the list is a heterogeneous list.
8. Rewards to different items in a target purchase pattern can be different;
9. Rewards for a purchase pattern can be presented as a choice of multiple options;
10. Multiple rewards can be applied to items in a purchase pattern;
11. A filter on matched purchase patterns is needed in the some cases to narrow the matched purchase patterns to the ones targeted by a promotion;
12. The quantity distribution as mentioned in the 3-step promotion evaluation process could be more than the distribution of quantity, it can base on either quantity (or to be more precise, the number of matches for a purchase pattern in the order) or spending, similarly a spending threshold distribution can be volume based or tiered;

Using the twelve observations made previously, a model for promotion evaluation will be defined. The following definitions, variables, constraints and notation will be used to describe the model and examples using the defined model which follows:
Notation:
   A set is denoted using a pair of curly braces {};
   A vector or matrix is denoted using a pair of brackets ( )
   In a mathematical expression, a pair of brackets ( ) also convey priority of operator association, e.g. a*(b+c) means+takes priority over *;
   Σxᵢ=x₁+x₂+ . . . +xₙ, semantics of “+” operation varies based on operand types;
   [ ]_{f} is a floor operation to convert real numbers to integers;
   A range of number a to b are denoted by [a,b], [a,b), (a,b] or (a,b), a square bracket indicates the boundary is included in the range;
   < > denotes a tuple;
   F(X, Y, Z) denotes that F is a function of X, Y and Z;
s is a SKU, which uniquely identify a purchasable entry in the catalog;
q is a quantity, it is a non-negative number;
u is a unit cost, it is a non-negative number, for any purchasable entries in the catalog, when SKUs are the same, unit costs are always the same;
l is a tuple of s, q and u, <s, q, u>, called line item;
L is a line item set, i.e. L={l₁, l₂, . . . lₙ} such that !∃i,j where 0<i<j<n+1, and lᵢ.s=lⱼ.s, note that L is not a vector, L is a scalar. Its type is a set.
for l the following comparison are defined:
   lᵢ=lⱼ when and only when l_{i.}.s=lⱼ.s and lᵢ.q=lj.q
   lᵢ≦lⱼ when and only when l_{i.}.s=lⱼ.s and lᵢ.q≦lⱼ.q
   lᵢ≦lⱼ when and only when l_{i.}.s=lⱼ.s and l_{i.}.q≧lⱼ.q
   l=lᵢ−lⱼ is valid when and only when lᵢ.s=lⱼ.s, the result l is defined as l.s=lᵢ.s=lⱼ.s and l.q=max{0, lᵢ.q−lⱼ.q};
   l=lᵢ+lⱼ is valid when and only when lᵢ.s=lⱼ.s, the result l is defined as l.s=lᵢ.s and l.q=lᵢ.q+lⱼ.q;

when L={l₁, l₂, . . . lₙ} the following comparison are defined:

Φ ={ };
lᵢ∈ L, l ≦i≦n;
$quantity ( L ) = {\sum }_{i = 1}^{n} ( {l}_{i} q ) ;$
$cost ( L ) = {\sum }_{i = 1}^{n} ( {l}_{i} q * {l}_{i} u ) ;$
Lᵢ ⊂ Lⱼ when ∀l∈ Lᵢ, ∃l′∈Lⱼ, such that l≦l′;
Lᵢ = Lⱼ when Lᵢ ⊂ Lⱼ and Lⱼ ⊂ Lᵢ;
Lᵢ ∪ Lⱼ = Lᵢ + Lⱼ is defined as:

L initially is set the same as Lᵢ, for each l in Lⱼ, if ∃ l′ in L such
that l.s = l′.s, then l′=l′+l, otherwise, l is added to L, L = Lᵢ+Lⱼ;

L=Lᵢ − Lⱼ is defined as:

Initially L=Φ,
for each l in Lᵢ, {

if ∃ l′ in Lⱼ such l.s = l′.s {

if ( l.q>l′.q) {

l.q=l.q − l′.q;
add l to L;

} else{

continue to next l;

}

} else {

add l to L;

}

}

Lᵢ ∩ Lⱼ is defined as L = Lᵢ ∩ Lⱼ=Lᵢ−(Lᵢ−Lⱼ)=Lⱼ−(Lⱼ−Lᵢ);
first(L,x) is defined as the following:

initially L′ is empty,
starting from the first l in L, for each l in L while (x > 0) {

if l.q ≦ x {

L′ = L′+{l};

}
else {

l.q = x
L′ = L′+{l};

}
x=x−l.q

}

L′ is first (L,x)

group(L,z,x), where L is a line item set, z is the size of a group and x is the index of that group. The function is defined as the following:
first(L,z*x)−first(L,z*(x−1))
f is a filter (or selection criteria, Observation 2), which is a function of L that returns another L′ such that L′=f(L)⊂L, f can be defined by continuously apply a sequence of f's, i.e. f=f₁(f₂( . . . fₙ₋₁(fₙ( )) . . . )), i.e. join a list of selection criteria by “and”. f_{ø} is a special type of filter where, ∀L, f_{ø}(L)=Φ, f_{c} is another special type of filter where ∀L, f_{c}(L)=L;
F is a filter list, i.e. a vector of filters (f₁, f₂, . . . , fₙ);
r is a weighted range of [m, n] where m and n are positive numbers m≦n, n is optional, when n is absent, ∞ is assumed, w is the weight of r, 0≦w≦1. A weighted ranged is introduced to define the quantity requirement of a pattern definition. (Observation 4 and 6)
operations defined for r are:

$$size ( q , r ) = min \{ max \{ m , q \} , ( {m}^{*} ( 1 - w ) + {n}^{*} w ) \}$$

$${L}^{′} = {r}^{*} L is defined as \text{:}$$

$$if L = \{ {l}_{1} , {l}_{2} , … , {l}_{n} , \} then {r}^{*} L = {L}^{′} = \{ {l}_{1}^{′} , {l}_{2}^{′} , … , {l}_{m}^{′} \} where$$

$$when i < m , {l}_{i}^{′} = {l}_{i}$$

$${l}_{m}^{′} \cdot q = {[ quantity ( L ) / size ( quantity ( L ) , r ) ]}_{f}^{*} size ( quantity ( L ) , r ) - {\sum }_{k = 1}^{m - 1} {l}_{k} \cdot q ;$$

$${l}_{m}^{′} \cdot s = {l}_{m} \cdot s ;$$

$$m is determined by the following rules$$

$$1. m ⩽ n$$

$$2. {and [ quantity ( L ) / size ( quantity ( L ) , r ) ]}^{*} size ( quantity ( L ) , r ) - {\sum }_{k = 1}^{m - 1} {l}_{k} \cdot q > 0$$

$$3. {and [ quantity ( L ) / size ( quantity ( L ) , r ) ]}^{*} size ( quantity ( L ) , r ) - {\sum }_{k = 1}^{m - 1} {l}_{k} \cdot q ⩽ 0$$
R is a range list, i.e. a vector of weighted ranges (r₁, r₂, . . . , rₙ)
A Pattern may then be described as a collection of constraints all of which need to be satisfied. (Observation 5) Each constraint defines that the number of SKUs that satisfy a selection criteria (f) present in the line item set (L) has to fall in a certain range (r). Function Occ(L) calculates how many times a pattern occurs in the L and function P(L) finds all the line items in L, groups them into line item sets each representing a match of that pattern;

$$For a given L , R = ( {r}_{1} , {r}_{2} , … , {r}_{n} ) , and F = ( {f}_{1} , {f}_{2} , … , {f}_{n} )$$

$$and ∀ i , j , i \neq j , {f}_{i} ( L ) ⋂ {f}_{j} ( L ) = Φ \text{:}$$

$$Occ ( L ) = {{min}_{i = 1}}^{n} \{ {[ \frac{quantity ( {f}_{i} ( L ) )}{size ( quantity ( {f}_{i} ( L ) ) , {r}_{i} )} ]}_{f} \}$$

P(L)={p₁, p₂, . . . , p_{Occ(L)}} where each pᵢ is a line item set, it contains the line items that represent one match of the pattern.
pᵢ={group(fₖ(L), size(quantity(fₖ(L)), rₖ), i)|kε[1, n]},
at(P(L),i)=pᵢ is a function that returns the i-th match of the pattern.

In the above formulas, R and F can be viewed as the configuration of the function, L is the parameter.

Expand the above concepts a bit further:

$$if {M}_{f} = ( \begin{matrix}( {f}_{11} , {f}_{12} , … , {f}_{1 {m}_{1}} ) \\ ( {f}_{21} , {f}_{22} , … , {f}_{2 {m}_{2}} ) \\ ⋯ \\ ⋯ \\ ( {f}_{n 1} , {f}_{n 2} , … , {f}_{n {m}_{n}} )\end{matrix} )$$

mᵢ and mⱼ may not be equal and for any a, b, c, and d, |a−b|+|c−d|≠0, 1≦a, b≦n, 1≦c≦mₐ, 1≦d≦m_{b} f_{ac}(L)∩f_{bd}(L)=Φ, Then following are the definitions for Occ(L) and P(L) for given R and M, let fᵢ(L)={rᵢ*fᵢₖ(L)|kε[1, mᵢ]}, and F′=(f₁, f₂, . . . , fₙ) then Occ(L) for R and M becomes Occ(L) for R and F′, similar results can be derived for P(L).

This construct is introduced to address the homogeneous list requirements we see in Observation 7.
For a pattern P(L)={p₁, p₂, . . . , p_{Occ(L)}} a pattern filter f is a filter, such that f(P(L))={pₖ₁, pₖ₂, . . . pₖₘ} and kᵢε[1, Occ(L)] for any i≠j, i,jε[1, m] kᵢ≠kⱼ
   Occ(f(P(L)))=m
   at(f(L),i)=pₖᵢ
      The pattern filter concept was first seen in Observation 11.
D is a distribution. D is a function of L, it is based on a pattern function P a pattern

$$filter {f}_{p} , and a segment list g = ( \begin{matrix}[ {min}_{1} , {max}_{1} ] \\ [ {min}_{2} , {max}_{2} ] \\ ⋯ \\ ⋯ \\ [ {min}_{n} , {max}_{n} ]\end{matrix} ) where$$

$$0 < {min}_{i} ⩽ {max}_{i} < {min}_{i + 1} , {max}_{n}$$

is optional, when maxₙ is absent, maxₙ=∞ s assumed. min and max can be the number of patterns present, or the spending threshold on patterns. L, P, fₚ and g can be viewed as the configurations of D. L is the parameter. There are two flavors of D, Dᵥ and Dₜ, i.e. volume based range and tiered range. (Observation 3) For the quantity based distribution, Dᵥ and Dₜ are defined below:

$$Let {P}^{′} = {f}_{p} ( P ( L ) ) = {f}_{p} ( \{ {p}_{1} , {p}_{2} , … , {p}_{k} \} ) = \{ {p}_{1}^{′} , {p}_{2}^{′} , … {p}_{m}^{′} \}$$

$${D}_{v} ( L ) = ( \begin{matrix} {P}_{1} = \{ \} \\ {P}_{2} = \{ \} \\ ⋯ \\ {P}_{i - 1} = \{ \} \\ {P}_{i} = {P}^{′} \\ {P}_{i + 1} = \{ \} \\ ⋯ \\ {P}_{n} = \{ \}\end{matrix} ) {D}_{t} ( L ) = ( \begin{matrix} {P}_{1} = \{ {p}_{{min}_{1}}^{′} , … , {p}_{{max}_{1}}^{′} \} \\ {P}_{2} = \{ {p}_{{min}_{2}}^{′} , … , {p}_{{max}_{2}}^{′} \} \\ ⋯ \\ . {P}_{i - 1} = \{ {p}_{{min}_{i - 1}}^{′} , … , {p}_{{max}_{i - 1}}^{′} \} \\ . {P}_{i} = \{ {p}_{{min}_{n}}^{′} , … , {p}_{m}^{′} \} \\ {P}_{i + 1} = \{ \} \\ ⋯ \\ {P}_{n} = \{ \}\end{matrix} )$$

$$where {min}_{i} ⩽ m ⩽ {max}_{i}$$

Similar Dᵥ and Dₜ can be calculated for spending threshold based on the cost function of line item set. (Observation 12)
A purchase condition, may then be described as the following
Purchase condition works on an input parameter: line item set L, usually initialized based on the content of an order. It is defined by a distribution D. The distribution is configured by a pattern P, a pattern filter fₚ and a segment list g. The pattern function P is itself configured by afilter list F and a weighted range list R.

$$If D ( L ) = ( \begin{matrix}{P}_{1} = \{ {p}_{11} , {p}_{12} , … , {p}_{1 {m}_{1}} \} \\ {P}_{2} = \{ {p}_{21} , {p}_{21} , … , {p}_{2 {m}_{2}} \} \\ ⋯ \\ {P}_{n} = \{ {p}_{n 1} , {p}_{n 2} , … , {p}_{n {m}_{n}} \}\end{matrix} ) ,$$

each pᵢⱼ is a line item set. It contains the line items in L that make up one match for the pattern; the content of Pᵢ is determined by the distribution logic mentioned earlier in this document;
If for D(L)=(P₁, P₂, . . . , Pₙ)^{T} and P₁=P₂= . . . =Pₙ={}, then the purchase condition is NOT satisfied, otherwise the purchase condition is satisfied.
δ is an adjustment function of line item set L. δ is from a predefined set which include but not limited to elements of the following matrix. The element in the matrix needs to be configured before used to construct promotions, e.g. the adjustment amount need to be set for FixedAmountOff:

$$( \begin{matrix}PercentOff \\ FixedAmountOff \\ FixedCostice \\ PercentOffShipping \\ FixedAmountOffShipping \\ FixedCostShipping \\ ShippingUpgradeAtExtraCost \\ FreePurchasableGift \\ FreeNonPurchasableGift \\ Voucher \\ ItemUpgradeAtFixedExtraCost \\ TaxBreakAsMatchingAmountOff \\ CustomNumericValue\end{matrix} ) \times ( L as a whole , order as a whole , each item in L )$$
a is a reward function of a line item set L. L usually is a match of a purchase pattern, i.e., it contains all the line items that make up a match for a purchase pattern. a is defined as: a (L) where:
For given (δ₁, δ₂, . . . , δₙ) and (f₁, f₂, . . . , fₙ):

$$a ( L ) = ( {δ}_{1} , {δ}_{2} , … {δ}_{n} ) * ( \begin{matrix}{f}_{1} ( L ) \\ {f}_{2} ( L ) \\ ⋯ \\ {f}_{n} ( L )\end{matrix} ) = {\sum }_{i = 1}^{n} {δ}_{i} ( {f}_{i} ( L ) )$$

In the above formula, δ₁, δ₂, . . . , and δₙ as well as f₁, f₂, . . . , fₙ can be viewed as the configuration of α and line item set L is the only parameter; The expression can be interpreted as the collective result of applying adjustment of δᵢ to a sub set of L as identified by filter fᵢ.

The above definition reflects observation 8, where different items in the purchase pattern match can be rewarded differently. The filters fᵢ determines the set of items in a purchase pattern match (L) that will be rewarded by applying δᵢ to them;

Also, note that it was NOT specified that fᵢ(L)∩fⱼ(L) has to be an empty set. When fᵢ(L)∩fⱼ(L) is not empty, which means certain items in L are rewarded by both δᵢ and δⱼ, i.e. multiple rewards can be applied to the same item(s). (Observation 10)
Once a purchase condition is satisfied, the 3 step process of evaluating a promotion may then be expressed as (a₁, a₂, . . . , aₙ)*D(fₚ(P(L))=(a₁, a₂, . . . , aₙ)*(P₁, P₂, . . . , Pₙ)^{T} (Observation 1):

$${\sum }_{i = 1}^{n} {\sum }_{j = 1}^{{m}_{i}} {α}_{i} ( {p}_{ij} ) = \{ \begin{matrix}{α}_{1} ( {p}_{11} ) , {α}_{1} ( {p}_{12} ) , … {α}_{1} ( {p}_{1 {m}_{1}} ) , \\ {α}_{2} ( {p}_{21} ) , {α}_{2} ( {p}_{22} ) , … {α}_{2} ( {p}_{2 {m}_{1}} ) , \\ ⋯ \\ ⋯ \\ {α}_{n} ( {p}_{n 1} ) , {α}_{n} ( {p}_{n 2} ) , … {α}_{n} ( {p}_{n {m}_{n}} )\end{matrix} \}$$

It should be noted that the result is a set and not a matrix, as it is expressed in a line by line format to illustrate that each line may have a different reward associated with it;

If a choice of different rewards may be granted for patterns in a segment in the distributions (Observation 9), the reward may then be rewritten as:

$$\{ \begin{matrix}Choice ( ( \begin{matrix}{α}_{11} \\ {α}_{12} \\ ⋯ \\ {α}_{1 {k}_{1}}\end{matrix} ) , {p}_{11} ) , Choice ( ( \begin{matrix}{α}_{11} \\ {α}_{12} \\ ⋯ \\ {α}_{1 {k}_{1}}\end{matrix} ) , {p}_{12} ) , … , Choice ( ( \begin{matrix}{α}_{11} \\ {α}_{12} \\ ⋯ \\ {α}_{1 {k}_{1}}\end{matrix} ) , {p}_{1 {m}_{1}} ) , \\ Choice ( ( \begin{matrix}{α}_{21} \\ {α}_{22} \\ ⋯ \\ {α}_{2 {k}_{2}}\end{matrix} ) , {p}_{21} ) , Choice ( ( \begin{matrix}{α}_{21} \\ {α}_{22} \\ ⋯ \\ {α}_{2 {k}_{2}}\end{matrix} ) , {p}_{22} ) , … , Choice ( ( \begin{matrix}{α}_{21} \\ {α}_{22} \\ ⋯ \\ {α}_{2 {k}_{2}}\end{matrix} ) , {p}_{2 {m}_{2}} ) , \\ ⋯ \\ Choice ( ( \begin{matrix}{α}_{n 1} \\ {α}_{n 2} \\ ⋯ \\ {α}_{{nk}_{n}}\end{matrix} ) , {p}_{n 1} ) , Choice ( ( \begin{matrix}{α}_{n 1} \\ {α}_{n 2} \\ ⋯ \\ {α}_{{nk}_{n}}\end{matrix} ) , {p}_{n 2} ) , … , Choice ( ( \begin{matrix}{α}_{n 1} \\ {α}_{n 2} \\ ⋯ \\ {α}_{{nk}_{n}}\end{matrix} ) , {p}_{n {m}_{n}} )\end{matrix} \}$$

$$Where Choice ( ( \begin{matrix}{α}_{1} \\ {α}_{2} \\ ⋯ \\ {α}_{n}\end{matrix} ) , L ) = {α}_{i} ( L ) where 1 ⩽ i ⩽ n , i . e . a choice between \\ {a}_{1} ( L ) , {a}_{2} ( L ) , … , {a}_{n} ( L ) .$$

The above model concepts will now be applied to promotion examples to illustrate the use of the model technique. The first example is based on the promotion described in promotion 1: Buy 1 to 10 T-Shirts get 10% off the price, buy 11-1000 get 20% off, buy more than 1000 get 30% off, which is an example of pure volume based pricing. The three step process illustrated earlier will now be used in conjunction with the just derived model to create a promotion evaluation technique. In a first step define the promotion and let:
filters
   f_{c}(L)=L (i.e. f_{c} does not eliminate any line items in L),
   fₜ₋ₛₕᵢᵣₜ(L)=L′ where ∀ₗ lᵢεL′ lᵢ belongs to category T-Shirt, F=(fₜ₋ₛₕᵢᵣₜ);
Pattern filter
   f_{pc}P(L))=P(L), it does not eliminate any patterns
weighted range
   r₁=[1, l] with weight w=0, R=(r₁);
Pattern is defined as:
   P is configured by R, F, i.e. (r₁) and (fₜ₋ₛₕᵢᵣₜ)
distribution

$$D = ( \begin{matrix}[ 1 , 10 ] \\ [ 11 , 1000 ] \\ [ 1001 , ∞ )\end{matrix} ) and D$$

is a volume based quantity distribution
adjustment functions
   δ₁(L)=10% off every item in L,
   δ₂(L)=20% off every item in L,
      δ₃(L)=30% off every item in L,
rewards
   a₁(L)=δ₁(f_{c}(L)),
   a₂(L)=δ₂(f_{c}(L)),
   a₃(L)=δ₃(f_{c}(L))

Then apply the defined promotion to a scenario, where the
shop cart contains
   10 Red XL T-Shirts
   5 Red Green M T-Shirts
   4 White M T-Shirts
   10 pairs of sneakers
Flow:
1. Initialize
   L={l₁, l₂, l₃, l₄},
   l₁.s=RED XL T-Shirt, l₁.q=10, l₁.u=$10.00
   l₂.s=RED M T-Shirt, l₁.q=5, l₁.u=$8.00
   l₃.s=White M T-Shirt, lᵢ.q=4, l₁.u=$8.00
   l₄.s=Sneakers, l₁.q=10, l₁.u=$80.00
2. Based on the above definition,

$$\begin{matrix}Occ ( L ) = {{min}^{1}}_{i = 1} \{ {[ \frac{quantity ( {f}_{t \text{-} shirt} ( L ) )}{size ( quantity ( {f}_{t \text{-} shirt} ( L ) , {r}_{1} )} ]}_{f} \} = 19 \\ P ( L ) = \{ {p}_{1} , {p}_{2} , , … , {p}_{19} \} \\ {p}_{1} = \{ l \} , where l . s = RED XL T \text{-} Shirt , l . q = 1 , l . u = \$10 .00 \\ = … \\ {p}_{10} = \{ l \} , where l . s = RED XL T \text{-} Shirt , l . q = 1 , l . u = \$10 .00 \\ {p}_{11} = \{ l \} , where l . s = RED M T \text{-} Shirt , l . q = 1 , l . u = \$8 .00 \\ = … \\ {p}_{15} = \{ l \} , where l . s = RED M T \text{-} Shirt , l . q = 1 , l . u = \$8 .00 \\ {p}_{16} = \{ l \} , where l . s = White M T \text{-} Shirt , l . q = 1 , l . u = \$8 .00 \\ = … \\ {p}_{19} = \{ l \} , where l . s = White XL T \text{-} Shirt , l . q = 1 , l . u = \$8 .00\end{matrix}$$

Next, perform filtering on the resultant pattern, distribute the result according to the distribution defined above and apply the rewards. The steps may then be expressed as:

$$\begin{matrix}( {a}_{1} , {a}_{2} , {a}_{3} ) * D ( {f}_{pc} ( P ( L ) ) ) = ( {α}_{1} , {α}_{2} , {α}_{3} ) * ( \begin{matrix}\{ \} \\ {f}_{pc} ( \{ {p}_{1} , {p}_{2} , … , {p}_{19} \} ) \\ \{ \}\end{matrix} ) \\ = ( {α}_{1} , {α}_{2} , {α}_{3} ) * ( \begin{matrix}\{ \} \\ \{ {p}_{1} , {p}_{2} , … , {p}_{19} \} \\ \{ \}\end{matrix} )\end{matrix}$$

The result of the above expression is:

$$\begin{matrix}\{ {α}_{2} ( {p}_{1} ) , {α}_{2} ( {p}_{12} ) , … {α}_{2} ( {p}_{19} ) \} = \{ {δ}_{2} ( {f}_{c} ( {p}_{1} ) ) , {δ}_{2} ( {f}_{c} ( {p}_{2} ) ) , … , \\ {δ}_{2} ( {f}_{c} ( {p}_{19} ) ) \} \\ = {\sum }_{i = 1}^{19} {δ}_{2} ( {p}_{i} )\end{matrix}$$

i.e. for all of the 19 t-shirts, take 20% off for each. This is due to the allocation of the purchase quantity into the slot for a reward of 20% off and is applicable to the whole purchase quantity as described in the promotion. No filtering was applied as the promotion was a simple volume based pricing constraint example.

In a second example it would appear to be similar to promotion number 10 earlier, but there is an additional constrain applied: Buy 2 or more of this list of products (T-Shirts, Pens, Glasses) for 20% off and get free shipping for Disney Club members. First, when this promotion is created, the targeting condition will be set to target the Disney Club members. Once the Disney constraint has been resolved, the definition of the promotion may then be reduced to: Buy 2 or more of this list of products (T-Shirts, Pens, Glasses) for 20% off and get free shipping, which is the same as promotion 10 earlier. In a first step then define the promotion and let:
filters
   f_{c}(L)=L (i.e. f_{c} does not eliminate any line items in L),
   f_{tpg}(L)=L′ where ∀ₗlᵢεL′ lᵢ belongs to category T-Shirt, Pens or Glasses,
   F=(f_{tpg});
Pattern filter
   f_{pc}(P(L))=P(L), f_{pc} is a pattern based filter, and it does not eliminate any patterns
weighted range
   r₁=[1, 1] with weight w=0, R=(r₁);
Pattern is defined as:
   P is configured by R, F, i.e. (r₁) and (f_{tpg})
distribution
   D=([2, ∞)) and D is a volume based quantity distribution
adjustment functions
   δ₁₁(L)=20% off every item in L,
   δ₁₂(L)=free shipping for every item in L,
rewards
   a₁(L)=(δ₁₁, δ₁₂)*(f_{c}L), f_{c}(L))^{T}=δ₁₁(f_{c}(L))+δ₁₂(f_{c}(L))

Then apply the promotion using a first scenario:
shop cart contains
   1 Red XL T-Shirts
Flow:
1. Initialize
   L={l₁},
   l₁.s=RED XL T-Shirt, l₁.q=1, l₁.u=$10.00
2. Based on the above definition,

$$\begin{matrix}Occ ( L ) = {{min}^{1}}_{i = 1} \{ {[ \frac{quantity ( {f}_{tpg} ( L ) )}{size ( quantity ( {f}_{tpg} ( L ) , {r}_{1} )} ]}_{f} \} = 1 \\ p ( L ) = \{ {p}_{1} \} = \{ \{ l \} \} , where \\ l . s = RED XL T \text{-} Shirt , \\ l . q = 1 , \\ l . u = \$10 .00\end{matrix}$$

Next, perform filtering on the resultant pattern, and distribute the result according to the distribution. The steps may then be expressed as: D(f_{pc}(P(L)))=({}), i.e. the purchase condition is not satisfied. The purchase condition was not met because there was only one item in the cart. Now using a second scenario with different items in the cart and the shop cart now contains:
1 Red XL T-Shirts
2 Wine glasses
1 Fountain Pen

The flow becomes:
1. Initialize
   L={l₁, l₂, l₃},
   l₁.s=RED XL T-Shirt, l₁.q=1, l₁.u=$10.00
   l₁.s=Wine glasses, l₁.q=2, l₁.u=$32.00
   l₁.s=Fountain Pen, l₁.q=1, l₁.u=$20.00
2. Based on the above definition,

$$\begin{matrix}Occ ( L ) = {{min}^{1}}_{i = 1} \{ {[ \frac{quantity ( {f}_{tpg} ( L ) )}{size ( quantity ( {f}_{tpg} ( L ) , {r}_{1} )} ]}_{f} \} = 4 \\ P ( L ) = \{ {p}_{1} , {p}_{2} , {p}_{3} {p}_{4} \} \\ {p}_{1} = \{ l \} , where l . s = RED XL T \text{-} Shirt , l . q = 1 , l . u = \$10 .00 \\ {p}_{2} = \{ l \} , where l . s = Wine glass , l . q = 1 , l . u = \$32 .00 \\ {p}_{3} = \{ l \} , where l . s = Wine glass , l . q = 1 , l . u = \$32 .00 \\ {p}_{4} = \{ l \} , where l . s = Fountain Pen , l . q = 1 , l . u = \$20 .00\end{matrix}$$

Next, perform filtering on the resultant pattern, and distribute the results according to the distribution defined above and then apply the rewards. The steps may then be expressed as:

$$\begin{matrix}( {a}_{1} ) * D ( {f}_{pc} ( P ( L ) ) ) = ( {a}_{1} ) * ( {f}_{pc} ( \{ {p}_{1} , {p}_{2} , {p}_{3} {p}_{4} \} ) \\ = ( {a}_{1} ) * ( \{ {p}_{1} , {p}_{2} , {p}_{3} {p}_{4} \} ) \\ = \{ {a}_{1} ( {p}_{1} ) , {a}_{1} ( {p}_{2} ) , {a}_{1} ( {p}_{3} ) , {a}_{1} ( {p}_{4} ) \} \\ = \{ {δ}_{11} ( {f}_{c} ( {p}_{1} ) ) + {δ}_{12} ( {f}_{c} ( {p}_{1} ) ) , {δ}_{11} ( {f}_{c} ( {p}_{2} ) ) + \\ {δ}_{12} ( {f}_{c} ( {p}_{2} ) ) , {δ}_{11} ( {f}_{c} ( {p}_{3} ) ) + {δ}_{12} ( {f}_{c} ( {p}_{3} ) ) , \\ {δ}_{11} ( {f}_{c} ( {p}_{4} ) ) + {δ}_{11} ( {f}_{c} ( {p}_{4} ) ) \} \\ = \{ {δ}_{11} ( {p}_{1} ) + {δ}_{12} ( {p}_{1} ) , {δ}_{11} ( {p}_{2} ) + \\ {δ}_{12} ( {p}_{2} ) , + {δ}_{11} ( {p}_{3} ) + {δ}_{12} ( {p}_{3} ) , {δ}_{11} ( {p}_{4} ) + {δ}_{12} ( {p}_{4} ) \}\end{matrix}$$

In a third example a promotion is described as follows: Make an order on the site, and get 1 reward point for each dollar spent; spend over 100, and get 2 reward points for each dollar spent; spend over 200 dollars, and get 3 reward points for each dollar spent. As before first define the promotion and let:
filters
   f_{c}(L)=L (i.e. f_{c} does not eliminate any line items in L),
Pattern filter
   f_{pc}(P(L))=P(L), it does not eliminate any patterns
weighted range
   r₁=[l, ∞) with weight w=1, R=(r₁), i.e. all the items are included in the pattern (an entire order);
Pattern is defined as:
   P is configured by R, F, i.e. (r₁) and (f_{c})
distribution

$$D = ( \begin{matrix}( 0 , 100 ] \\ ( 100 , 200 ] \\ ( 200 , ∞ )\end{matrix} ) and D$$

is a tiered volume based spending distribution
adjustment functions
   δ₁(L)=1% of order total value custom numeric value (use the value as reward points),
   δ₂(L)=2% of order total value custom numeric value,
   δ₃(L)=3% of order total value custom numeric value,
rewards
   a₁(L)=δ₁(f_{c}(L)),
   a₂(L)=δ₂(f_{c}(L)),
   a₃(L)=δ₃(f_{c}(L))

It may then be appreciated that with an order worth $250, a customer will indeed get 750 reward points when this promotion is applied.

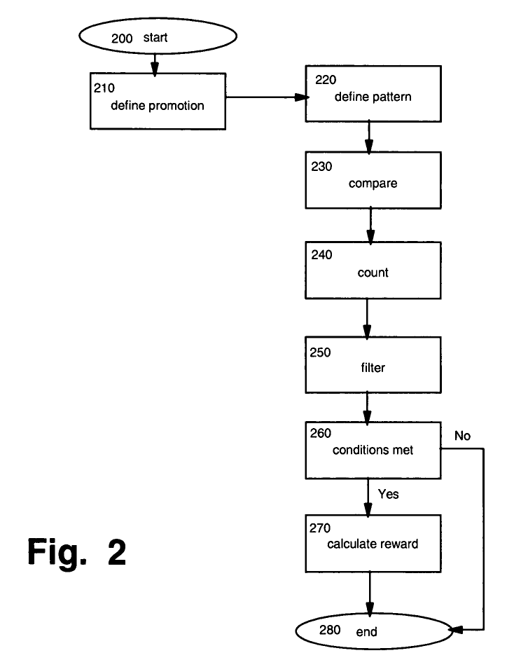

The process just described by way of examples may be summarized with the use of a flowchart of FIG. 2. The process begins in operation 200 where necessary setup may be performed. The promotion is then defined for use by the remainder of the process during operation 210. During operation 220 the promotion definition is used to create a pattern used as the target during evaluation. Next during operation 230 the pattern just defined is compared by normal comparator means with the items being purchased usually obtained from the shop cart. During the next operation 240 the number of matches or occurrences is counted to determine the quantity of matched patterns with the processing then moving to operation 250. During operation 250 any necessary filtering may be performed to further meet target consideration of the promotion and therefore reduce the quantity of matches. Next in operation 260 a determination is made regarding having met all of the specified conditions of the promotion. If conditions have not been met processing moves to end at operation 280, otherwise processing moves to operation 270. During operation 270 the rewards are calculated as per the promotion definition. After completing reward processing during operation 270 processing moves to end at operation 280 to complete the pattern based promotion evaluation. The process may then be repeated as needed for additional promotions or shoppers.

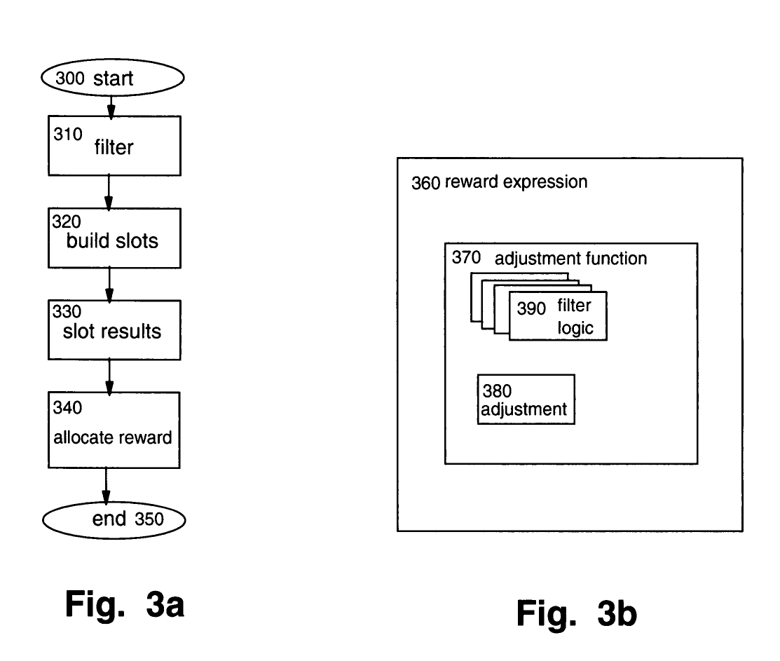

Calculating a reward may be further described using FIG. 3a. Reward processing begins after completion of identification of suitable matches for items in a shop cart with operation 300. Moving to operation 310 filtering is then performed on the provided matches to create groupings. Processing then moves to operation 320 during which “slots” are created based on distribution defined by the promotion definition. The distribution will be one of volume based or tiered. In the tiered case the “slots” will correspond to ranges for each tier. Next during operation 330 the results of the filtering are placed into the “slots” defined by the appropriate distribution definition. Then during operation 340 the actual reward is calculated in accordance with the reward specification from the promotion definition. Finally after completing the reward calculation processing moves to end at operation 350.

Reward processing may be seen in further detail in FIG. 3b. Reward expression 360 is actually a function containing other functions. Specifically it comprises obtaining a base reward definition which is reward expression 360 and with adjustment function 370 further containing filter logic 390 and adjustment 380. Filter logic 390 may be one or more filter logic instances. If there is more than one filter logic 390 they may be considered as a filter logic vector where each element of the vector provides another filter logic instance. Each filter logic instance is applied in succession to the previous instance. Adjustment 380 may be a single value or a computational expression such as a discount percentage.

The activity of evaluating promotions has therefore been expressed as matching patterns found in the current shopping order and then combined with the calculation of the corresponding rewards. Further the activity of creating promotions may be described as configuring the various attributes described such as filter, pattern filter, weighted range, reward, adjustment, distribution and assembling the attributes together.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

1. A computer implemented method for pattern based promotion evaluation based on a promotion definition for a plurality of items to be purchased for an electronic commerce application, comprising:
defining a purchase pattern of items derived from the promotion definition;
determining the defined purchase pattern of items within the plurality of items;
counting the number of occurrences of the defined purchase pattern found;
selectively applying a filter derived from the promotion definition to an occurrence;
determining promotion definition conditions having been met; and
determining one or more rewards from the promotion definition to complete the evaluation.

2. The method of claim 1, wherein determining one or more rewards comprises obtaining a base reward definition and applying an adjustment function containing a filter logic and an adjustment parameter derived from the promotion definition.

3. The method of claim 2, wherein the filter logic further comprises a filter logic vector of filter logic instances each filter logic instance combining with a previous filter logic instance.

4. The method of claim 1, wherein the defined pattern comprises at least a selection criteria and a quantity requirement of items.

5. The method of claim 4, wherein the quantity requirement comprises at least one of a number of occurrences of the defined pattern found in the plurality of items and a spending threshold.

6. The method of claim 4, wherein the quantity requirement comprises at least one of a single value and a range of items.

7. A computer system for pattern based promotion evaluation based on a promotion definition for a plurality of items to be purchased for an electronic commerce application, comprising:
a means for defining a purchase pattern of items derived from the promotion definition;
a means for determining the defined purchase pattern of items within the plurality of items;
a means for counting the number of occurrences of the defined purchase pattern found;
a selector for selectively applying a filter derived from the promotion definition to an occurrence;
a means for determining promotion definition conditions having been met; and
a means for determining one or more rewards from the promotion definition to complete the evaluation.

8. The computer system of claim 7, wherein the means for determining one or more rewards comprises obtaining a base reward definition and applying an adjustment function containing a filter logic and an adjustment parameter derived from the promotion definition.

9. The computer system of claim 8, wherein the filter logic further comprises a filter logic vector of filter logic instances each filter logic instance combining with a previous filter logic instance.

10. The computer system of claim 7, wherein the defined pattern comprises at least a selection criteria and a quantity requirement of items.

11. The computer system of claim 10, wherein the quantity requirement comprises at least one of a number of occurrences of the defined pattern found in the plurality of items and a spending threshold.

12. The computer system of claim 10, wherein the quantity requirement comprises at least one of a single value and a range of items.

13. An article of manufacture for directing a data processing system for pattern based promotion evaluation based on a promotion definition for a plurality of items to be purchased for an electronic commerce application, the article of manufacture comprising:
a computer usable medium embodying one or more instructions executable by the data processing system, the one or more instructions comprising:
data processing executable instructions for defining a purchase pattern of items derived from the promotion definition;
data processing executable instructions for determining the defined purchase pattern of items within the plurality of items;
data processing executable instructions for counting the number of occurrences of the defined purchase pattern found;
data processing executable instructions for selectively applying a filter derived from the promotion definition to an occurrence;
data processing executable instructions for determining promotion definition conditions having been met; and
data processing executable instructions for determining one or more rewards from the promotion definition to complete the evaluation.

14. The article of manufacture of claim 13, wherein the data processing executable instructions for determining one or more rewards comprises data processing executable instructions for obtaining a base reward definition and applying an adjustment function containing a filter logic and an adjustment parameter derived from the promotion definition.

15. The article of manufacture of claim 14, wherein the data processing executable instructions for the filter logic further comprises a filter logic vector of filter logic instances each filter logic instance combining with a previous filter logic instance.

16. The article of manufacture of claim 13, wherein the defined pattern comprises at least a selection criteria and a quantity requirement of items.

17. The article of manufacture of claim 16, wherein the quantity requirement comprises at least one of a number of occurrences of the defined pattern found in the plurality of items and a spending threshold.

18. The article of manufacture of claim 16, wherein the quantity requirement comprises at least one of a single value and a range of items.
